(19) United States
(12) Patent Application Publication
(10) Pub. No.: US 2012/0309244 A1
(43) Pub. Date: Dec. 6, 2012

(54) ELECTROLYTE MATERIAL

(75) Inventors: Samuel Solarski, La Madelleine (FR); Fabienne Piroux, Compiegne (FR)

(73) Assignee: Saint-Gobain Glass France, Courbevoie (FR)

(21) Appl. No.: 13/576,958

(22) PCT Filed: Feb. 22, 2011
(86) PCT No.: PCT/FR2011/050364

§ 371 Date: Aug. 3, 2012

(30) Foreign Application Priority Data
Feb. 23, 2010 (FR) 1051293

(51) Int. Cl. G02F 1/15; B32B 5/02; D04B 21/00; B32B 5/26; D03D 25/00

(52) U.S. Cl. 442/59; 359/265; 428/221; 442/381; 442/239; 442/318

(57) ABSTRACT

This electrolyte material for an electrically controllable device having variable optical/energy properties is in the form of a self-supported layer intended to be placed between two layers of electroactive material, and comprises or consists of a matrix which is capable of maintaining the mechanical strength thereof and in which are inserted ionic charges capable of allowing, under the action of a current, oxidation and reduction reactions in adjacent layers of electroactive material. The ionic charges are within the matrix in the solubilized state, solubilized by a solubilization liquid (L). The matrix is chosen to provide the percolation pathway for the ionic charges. According to the invention, the matrix is based on a textile sheet (TS) or on a stack of sheets including at least one textile sheet (TS), the textile sheet or the stack being translucent or transparent once impregnated by the liquid (L) that has solubilized the organic compounds and the ionic charges, and being capable of retaining at least a portion of its integrity once impregnated by the liquid (L).

The present invention relates to an electrolyte material for an electrically controllable device said to have variable optical and/or energy properties, to a process and a kit for manufacturing this material, to an electrically controllable device and to glazing units using such an electrolyte material.

Such an electrically controllable device may be defined in a general manner as comprising the following stack of layers:
a first substrate having a glass function;
a first electronically conductive layer with an associated current feed;
an electroactive system;
a second electronically conductive layer with an associated current feed; and
a second substrate having a glass function.

The invention relates to layered electroactive systems that comprise two layers of electroactive material separated by one layer of electrolyte material, the electroactive material of at least one of the two layers being electrochromic. In the case where both electroactive materials are electrochromic materials, these may be identical or different. In the case where one of the electroactive materials is electrochromic and the other is not, the latter will have the role of a counterelectrode that does not participate in the coloring and bleaching processes of the system. Under the action of an electric current, the ionic charges of the layer of electrolyte material are inserted into one of the layers of electrochromic material and are ejected from the other layer of electrochromic material or counterelectrode to obtain a color contrast.

As examples, the electrochromic and counterelectrode layers may be based on a polymer such as poly(3,4-ethylenedioxythiophene) (PEDOT), or on inorganic compounds such as WO₃.

In accordance with a first prior art, the electrolytes are composed of thin inorganic layers (the “All Solid” technology of Saint-Gobain), as described for example in patent EP 1 451 634, such thin inorganic layers being, for example, made of iridium oxide or tungsten oxide.

In accordance with a second prior art, the electrolyte comprises a solution or else a more or less viscous gel based on a polymer such as polyethylene oxide and polymethyl methacrylate, on one or more ionic salts and on one or more solvents and additives.

In accordance with a third prior art, the electrolyte may be a self-supported polymer film of several hundreds of micron in thickness based on a polymer such as polyvinyl butyral (PVB) into which one or more ionic salts have been introduced and also one or more plasticizers or additives. Such a system is described in European patent application EP 1 647 033.

In accordance with a fourth prior art, the electrolyte comprises a self-supported polymer matrix, into which the ionic charges are inserted, said polymer matrix containing within it a liquid (L) that solubilizes said ionic charges but that does not solubilize said self-supported polymer matrix, the latter being chosen to provide a percolation pathway for ionic charges in order to make said oxidation and reduction reactions of electroactive organic materials possible.

Such an electroactive material is described in international PCT application WO 2008/084168 in the name of the applicant company.

It is sought, in a general manner, to obtain electrically controllable devices having:
a good mechanical strength of the electroactive system and more particularly of the electrolyte layer;
coloring and bleaching transitions that are as homogeneous as possible, namely without a coloring or bleaching gradient from the edges towards the center (halo effect), and that are as fast as possible, preferably less than a few minutes irrespective of the size of the glazing units;
an absence of zones that do not have any coloring (pinholes); and
a high contrast between the colored state and the bleached state.

The various prior art above all have drawbacks:

Electrolytes made of thin inorganic layers are generally only used with inorganic electroactive layers, all these layers being obtained by vacuum deposition and in particular by magnetron sputtering or by electrodeposition. The development of a stack of this type is tricky with, in particular, a very high sensitivity to dust. As the electrolyte layer is very thin it is very difficult to obtain glazing units without “pinholes”, these being due to short circuits between the two electrochromic layers or the electrochromic layer and the counterelectrode layer.

The electroactive gel may creep or run when it has been placed in the electrically controllable device (such as a glazing unit), which will lead to leaks making the device unusable. The techniques for placing the gel in the electrically controllable devices are complicated to implement, consisting of a filling (“back-filling”) optionally under vacuum, sometimes followed by a polymerization step. Furthermore, it is difficult to expel all the air during this filling operation.

Finally, for large-sized glazing units, the large dimension of the equipment necessary for depositing the electrolyte medium or carrying out the filling operation with the gel becomes unacceptable.

In the case of electrolytes in the form of self-supported polymer films, the switching times are slow, sometimes more than several tens of minutes, due to the very low diffusion rate of ionic charges in a solid medium. Furthermore, even if these electrolytes have a self-supported film character at ambient temperature, they may be converted into a gel when they are exposed to temperature and therefore, during use in outside applications, with solar heating that may reach 80° C., leaks, via flow of the electrolyte material, are possible, making the device unusable.

In the case of the polymer film impregnated by an electrolyte solution, the development of the film may prove very difficult since the film must maintain the mechanical strength of the electrolyte medium, have sufficient porosity to allow, after impregnation, the percolation of ionic charges through the entire thickness of the electrolyte medium and above all must not be solubilized nor converted to a gel in the solvent of the electrolyte solution even when the electrically controllable device is subjected to temperatures ranging up to 80° C., or even higher. The polymer films corresponding to these criteria are furthermore expensive and not very durable, specifically risking breaking over time, which then results in a loss of the percolation network and in a loss of mechanical strength with formation of a gel. The polymer films that have, after impregnation, sufficient porosity to allow the percolation of ionic charges through the entire thickness of the electrolyte material are generally thin, with thicknesses of less than 150-200 μm, which does not make it possible to absorb the flatness defects of the substrate which may, for example, reach several tens of microns, or even a hundred microns, in the case of toughened glass.

The present invention provides a solution to these drawbacks and proposes to use, as a matrix, at least one textile sheet (TS), which makes it possible to have an easy implementation of the electrolyte medium via impregnation of the textile sheet(s) (TS) via an electrolyte solution (the latter being composed of ionic charges solubilized in a solubilization liquid (L)), the resulting self-supported electrolyte medium, which will be durable, then being able to be simply deposited on the substrate. The choice of a textile sheet (TS) furthermore offers possibilities of mixing various types of fibers, a portion of them being able to gel in the presence of the liquid for solubilization of the charges, the gel-intact fiber combination even offering improved creep resistance and making it possible to increase the tack (ability to bond) of the resulting electroactive medium, this resulting in an increase of the mechanical strength of the device.

It is possible to emphasize that with the novel structure according to the invention, it becomes conceivable to deposit the layers of electroactive material onto the surface of the matrix using conventional deposition techniques such as magnetron sputtering depositions for layers of electroactive material of inorganic nature, or using coating or spray depositions for layers of electroactive material of polymer nature.

Furthermore, it is possible according to the invention to adjust the thickness of the electrolyte layer, which may have a sufficient thickness for easy positioning, without however losing the good mobility of the ionic charges necessary for a rapid electrochromic system, that is to say one having short coloring and bleaching times.

One first subject of the present invention is therefore an electrolyte material for an electrically controllable device having variable optical/energy properties, which electrolyte material is in the form of a self-supported layer intended to be inserted between two layers of electroactive material, and comprises or consists of a matrix which is capable of maintaining the mechanical strength of said electrolyte material and in which are inserted ionic charges capable of allowing, under the action of an electric current, oxidation and reduction reactions in the adjacent layers of electroactive material, said ionic charges being found within said matrix in the solubilized state, solubilized by a solubilization liquid (L), said matrix furthermore being chosen to provide the percolation pathway for said ionic charges, characterized in that the matrix is based on a textile sheet (TS) or on a stack of sheets including at least one textile sheet (TS), said textile sheet (TS) or said stack being translucent or transparent once impregnated by the liquid (L) that has solubilized the ionic charges, and being capable of retaining at least one portion of its integrity once impregnated by the liquid (L) so that the strength of said electrolyte material is maintained.

In other words, the textile sheet (TS) or a textile sheet (TS) as defined above may be said to be at least partially insoluble in the liquid (L).

The textile sheet (TS) or a textile sheet (TS) may have a non-woven web or mat, woven fabric or knit fabric structure, this non-woven web or mat, this woven fabric or this knit fabric being, where necessary, coated with a binder, which may be at least partially soluble in the liquid (L) in order to form a gel.

The terms “non-woven web” and “mat” are each defined as being a film structure with fibers that are not woven and are not knitted together.

The terms “woven fabric” and “knit fabric” are defined as a matrix made of fibers and/or yarns that are respectively woven or knitted.

The woven fabrics and the knit fabrics have the advantage of a good cohesion of the yarns with each other in the absence of a binder. The binder, when it is used, makes it possible in particular to lightly gel the solubilization liquid (L), further improving the mechanical strength of the electrolyte material or even the tack of the resulting electrolyte material to the adjacent layers of electroactive material.

Each textile sheet (TS) may be composed of one or more types of fibers or yarns, the yarns being defined as assemblies of several fibers.

The textile sheet (TS) or a textile sheet (TS) is in particular based on synthetic (artificial) fibers and/or yarns, chosen in particular from fibers and/or yarns of polyolefin such as polypropylene (PP), of polyester, of fluoropolymer such as polytetrafluoroethylene (PTFE) or polyvinylidene fluoride (PVDF), of polyamide or of polyimide; and/or based on mineral fibers such as glass fibers, and/or based on natural fibers and/or yarns, such as cotton or wool fibers and/or yarns.

In accordance with a first variant, the textile sheet (TS) or a textile sheet (TS) is based on single-component or multicomponent fibers and/or yarns, the multicomponent fibers and/or yarns being, in particular, hybrid fibers and/or yarns or fibers and/or yarns comprising a core of a chemically resistant material, capable of retaining its integrity during the impregnation by the solubilization liquid (L) in order to maintain the mechanical strength of the electrolyte material, and at least one sheathing of a material soluble in the solubilization liquid (L) or capable of giving a gel during the impregnation of the textile sheet (TS) or of the stack of sheets by the impregnation liquid (L).

As examples of hybrid yarns, mention may be made of the Twintex® fibers (Owens Corning) which combine glass and polypropylene.

In accordance with a second variant, the textile sheet (TS) or a textile sheet (TS) is based on fibers and/or yarns that are insoluble in the solubilization liquid (L) and on fibers and/or yarns that are soluble in the solubilization liquid (L), the fibers and/or yarns thus solubilized having resulted in the formation of a gel. The amount of insoluble fibers and/or yarns relative to the amount of soluble fibers and/or yarns will be chosen so that the mechanical strength of the electrolyte material is maintained.

Systems that combine fibers and gel will be mechanically stronger than a system based on fibers and liquid.

In accordance with a third variant, the textile sheet (TS) or a textile sheet (TS) of the stack is a textile sheet coated with a material that is soluble in the solubilization liquid (L) or that is capable of giving a gel during the impregnation of the textile sheet or of the stack of sheets by the solubilization liquid (L); mention may be made of the use of webs or woven fabrics coated with polymer such as the silicone-coated glass cloths sold by Saint-Gobain Performance Plastics under the trade mark COHRlastic®, the liquid (L) swelling or solubilizing the coating polymer.

The textile sheet (TS) or a textile sheet (TS) may have a thickness of 50 μm to 4 mm, the fibers that form it having a diameter of 50 nm to 100 μm. In the electrolyte medium of the electroactive device, it will be preferred to use textile sheets having a thickness of 400 μm to 1 mm composed of fibers having a diameter between 1 μm and 20 μm. It is possible, for the matrix, to use fibers or yarns of the same diameter or of different diameters.

Mention may be made of the use of a single textile sheet (TS) or of a stack of several textile sheets (TS), the latter being identical or having different natures, and/or having different yarn diameters.

The ionic charges may be carried by at least one ionic salt and/or at least one acid solubilized in said liquid (L) and/or by said matrix.

The solubilization liquid (L) may be constituted by a solvent or a mixture of solvents and/or by at least one ionic liquid or salt that is molten at ambient temperature, said ionic liquid or molten salt or said ionic liquids or molten salts then constituting a solubilization liquid bearing ionic charges, which charges represent all or some of the ionic charges of said electrolyte material.

The ionic salt(s) may be chosen in particular from lithium perchlorate, trifluoromethanesulfonate or triflate salts, trifluoromethanesulfonylimide salts and ammonium salts.

The acid(s) may be chosen from sulfuric acid (H₂SO₄), triflic acid (CF₃SO₃H), phosphoric acid (H₃PO₄) and polyphosphoric acid (Hₙ₊₂PₙO₃ₙ₊₁).

The solvent(s) may be chosen from sulfolane; dimethylsulfoxide; dioxane; amides such as N,N-dimethylformamide and N,N-dimethylacetamide; 1-methyl-2-pyrrolidinone; carbonates such as propylene carbonate, ethylene carbonate and butylene carbonate; ethylene glycols such as tetraglyme; alcohols such as ethanol and ethoxyethanol; ketones such as cyclopentanone and benzylacetone; lactones such as γ-butyrolactone and acetylbutyrolactone, nitriles such as acetonitrile, glutaronitrile and 3-hydroxypropionitrile; anhydrides such as acetic anhydride; ethers such as 2-methoxyethyl ether; water; phthalates; adipates; citrates; sebacates; maleates; benzoates and succinates.

The ionic liquid(s) may be chosen from imidazolium salts, such as 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethyl sulfonyl)imide (emim-N(CF₃SO₂)₂ or emim-TSFI) and 1-butyl-3-methylimidazolium bis(trifluoro-methylsulfonyl)imide (bmim-N(CF₃SO₂)₂ or bmim-TSFI).

The concentration of the ionic salt(s) and/or of the acid(s) in the solvent or the mixture of solvents is especially less than or equal to 5 mol/l, preferably less than or equal to 2 mol/l, more preferably still less than or equal to 1 mol/l.

The or each solvent may be chosen from those having a boiling point at least equal to 70° C., preferably at least equal to 150° C.

The solubilization liquid (L) may also contain, in addition, at least one thickener, which will be solubilized in said liquid (L) so as to form a gel.

The thickener may especially be chosen from:
homopolymers or copolymers that do not comprise ionic charges, in which case these charges are carried by at least one aforementioned ionic salt or solubilized acid and/or by at least one ionic liquid or molten salt;
homopolymers or copolymers comprising ionic charges, in which case supplementary charges that make it possible to increase the percolation rate may be carried by at least one aforementioned ionic salt or solubilized acid and/or by at least one ionic liquid or molten salt; and
blends of at least one homopolymer or copolymer that does not carry ionic charges and of at least one homopolymer or copolymer comprising ionic charges, in which case supplementary charges that make it possible to increase the percolation rate may be carried by at least one aforementioned ionic salt or solubilized acid and/or by at least one ionic liquid or molten salt.

The thickener may also be chosen from ethylene copoly-mers, vinyl acetate copolymers, ethylene/vinyl acetate copolymers (EVAs), polyurethanes (PUs), polyvinyl butyral (PVB), polyimides (PIs), polyamides (PAs), polystyrene (PS), polyvinylidene fluoride (PVDF), polyetherketones (PEKs), polyetheretherketones (PEEKs), epichlorohydrin copolymers, polyolefins, polyethylene oxide (POE), polyacrylates, polymethyl methacrylate (PMMA) and silicones, or the derivatives thereof or the monomers thereof or else the prepolymers thereof.

The thickener may also be chosen from polyelectrolytes and especially sulfonated polymers which have undergone an exchange of the H⁺ ions of the SO₃H groups with the ions of the desired ionic charges. The sulfonated polymers are especially chosen from sulfonated copolymers of tetrafluoroethylene, sulfonated polystyrenes (PSSs), copolymers of sulfonated polystyrene, poly(2-acrylamido-2-methyl-1-propanesulfonic acid) (PAMPS), sulfonated polyetheretherketones (PEEKs) and sulfonated polyimides.

The matrix may also be formed by a stack of sheets, which comprises, besides the textile sheet(s) (TS) that are at least partially insoluble in the liquid (L), at least one non-textile sheet (NTS) in which the solubilization liquid (L) has penetrated to the core in order to swell it or solubilize it, and/or at least one textile sheet (TS') that is soluble in the liquid (L).

A “non-textile sheet” is defined as being a polymer sheet without a fibrous matrix.

The polymer constituting at least one polymer sheet of the matrix as defined in the preceding paragraph may be a homopolymer or copolymer that is in the form of a film that is non-porous but capable of swelling in said liquid, or that is in the form of a porous film, said porous film optionally being capable of swelling in the liquid comprising ionic charges and the porosity of which after swelling is chosen in order to allow the percolation of ionic charges in the thickness of the liquid-impregnated film. The polymer constituting at least one sheet may also be soluble in said liquid (L).

The polymer constituting at least one polymer sheet may also be chosen from:
homopolymers or copolymers that do not comprise ionic charges, in which case these charges are carried by at least one aforementioned ionic salt or solubilized acid and/or by at least one ionic liquid or molten salt;
homopolymers or copolymers comprising ionic charges, in which case supplementary charges that make it possible to increase the percolation rate may be carried by at least one aforementioned ionic salt or solubilized acid and/or by at least one ionic liquid or molten salt; and
blends of at least one homopolymer or copolymer that does not carry ionic charges and of at least one homopolymer or copolymer comprising ionic charges, in which case supplementary charges that make it possible to increase the percolation rate may be carried by at least one aforementioned ionic salt or solubilized acid and/or by at least one ionic liquid or molten salt.

The polymer(s) of a polymer sheet not comprising ionic charges may be chosen from ethylene copolymers, vinyl acetate copolymers, ethylene/vinyl acetate copolymers (EVAs), polyurethanes (PUs), polyvinyl butyral (PVB), polyimides (PIs), polyamides (PAs), polystyrene (PS), polyvinylidene fluoride (PVDF), polyetherketones (PEKs), polyetheretherketones (PEEKs), epichlorohydrin copolymers, polyolefins, polyethylene oxide (POE), polyacrylates, polymethyl methacrylate (PMMA) and silicones, or the derivatives thereof or the monomers thereof or else the prepolymers thereof.

The polymer(s) of a polymer sheet carrying ionic charges may be chosen from polyelectrolytes and especially sulfonated polymers which have undergone an exchange of the H⁺ ions of the SO₃H groups with the ions of the desired ionic charges, this ion exchange having taken place before and/or at the same time as the impregnation of the matrix, constituted by the stack of the textile sheet(s) (TS) with the polymer sheet(s), in the liquid comprising ionic charges, the sulfonated polymers especially being chosen from sulfonated copolymers of tetrafluoroethylene, sulfonated polystyrenes (PSSs), copolymers of sulfonated polystyrene, poly(2-acrylamido-2-methyl-1-propanesulfonic acid) (PAMPS), sulfonated polyetheretherketones (PEEKs) and sulfonated polyimides.

Furthermore, the matrix, constituted of at least one textile sheet (TS), and the liquid (L) are advantageously chosen so that the active medium withstands a temperature corresponding to the temperature required for a subsequent lamination or calendering step, namely a temperature of at least 80° C., in particular of at least 100° C.

The materials constituting the matrix and the solubilization liquid (L) may have different indices or indices that are essentially equal. It will be preferred for the indices to be essentially equal, with a difference of at most 0.10, or even of at most 0.05, so as to reduce the haze of the device.

By way of example, the matrix is constituted by at least one sheet of glass fibers, for example fibers of E glass (having a theoretical index of 1.55), and the solubilization liquid (L) is constituted by dimethylphthalate (having a theoretical index of 1.515). According to another example, the matrix is constituted by a sheet of polyvinylidene fluoride (PVDF) fibers (PVDF having a theoretical index of 1.42) and the solubilization liquid (L) is constituted by propylene carbonate having a theoretical index of 1.422.

Another subject of the present invention is a process for manufacturing an electrolyte material as defined previously within the context of the present invention, characterized in that the impregnation of said matrix, constituted of at least one textile sheet (TS), b_{y} the solubilization liquid (L) that has solubilized the ionic charges is carried out, and then a draining operation is carried out, where appropriate.

The immersion may be carried out for a time period from 2 minutes to 3 hours. The immersion may be carried out with heating, for example at a temperature of 40 to 80° C.

The immersion may also be carried out with the application of ultrasound to aid the penetration of the solubilization liquid into the matrix.

In addition, another subject of the present invention is a kit for manufacturing the electrolyte material as defined previously within the context of the present invention, characterized in that it consists of:
a self-supported matrix as defined previously within the context of the present invention; and
a solubilization liquid (L) of the ionic charges, in which said ionic charges have been solubilized.

Another subject of the present invention is an electrically controllable device having variable optical/energy properties, comprising an electrolyte material as defined previously within the context of the present invention, in particular such an electrically controllable device comprising the following stack of layers:
a first substrate having a glass function (V1);
a first electronically conductive layer (TCC1) with an associated current feed;
a first layer of ionic charge reservoir electroactive material, responding to a current;
said electrolyte material;
a second layer of ionic charge reservoir electroactive material, responding to a current;
a second electronically conductive layer (TCC2) with an associated current feed; and
a second substrate having a glass function (V2), at least one of the two layers of electroactive material being electrochromic, capable of changing color under the effect of an electric current, and the ionic charges of the electrolyte material being inserted into one of the layers of electroactive material and being ejected from the other layer of electroactive material during the application of a current in order to obtain a color contrast between the two layers of electroactive material.

The substrates having a glass function are especially chosen from glass (float glass, etc.) and transparent polymers, such as polymethyl methacrylate (PMMA), polycarbonate (PC), polyethylene terephthalate (PET), polyethylene naphthoate (PEN) and cycloolefin copoly-mers (COCs).

Within the context of the present invention, the electronically conductive layers used are denoted by “TCC”, an abbreviation for the expression “transparent conductive coating”, one example of which is a TCO (“transparent conductive oxide”).

The electronically conductive layers may also comprise a grid or a microgrid or be in the form of a grid or a microgrid; they may also comprise an organic and/or inorganic sublayer, especially in the case of plastic substrates.

The electronically conductive layers are especially layers of metallic type, such as layers of silver, of gold, of platinum and of copper; or layers of transparent conductive oxide (TCO) type, such as layers of tin-doped indium oxide (In₂O₃:Sn or ITO), of antimony-doped indium oxide (In₂O₃:Sb), of fluorine-doped tin oxide (SnO₂:F) and of aluminum-doped zinc oxide (ZnO:Al); or multilayers of the TCO/metal/TCO type, the TCO and the metal being especially chosen from those listed above; or multilayers of the NiCr/metal/NiCr type, the metal especially being chosen from those listed above.

Mention may be made, as an example of an electronically conductive layer, of a layer based on ITO having a thickness between 100 and 500 nm, preferably close to 110 nm or 300 nm; as a variant, it may be a multilayer comprising a stack of layers of ITO/ZnO:Al/Ag/ZnO:Al/ITO type, having respective thickness of 15 to 20 nm for ITO/60 to 80 nm for ZnO:Al/3 to 15 nm for silver/60 to 80 nm for ZnO:Al/15 to 20 nm for ITO, or else based on SnO₂:F having a thickness of around 350 nm. According to yet another variant, the electrically conductive layer may comprise other conductive elements: it may more particularly be a question of combining the electrically conductive layer with a layer that is more conductive than it, and/or with a plurality of conductive wires or strips. For further details reference will be made in particular to international PCT application WO 00/57243 for the use of such multicomponent electrically conductive layers.

When the electrochromic system is intended to work in transmission, the electrically conductive materials are generally transparent oxides for which the electronic conduction has been amplified by doping, such as In₂O₃:Sn, In₂O₃:Sb, ZnO:Al or SnO₂:F. Tin-doped indium oxide (In₂O₃:Sn or ITO) is frequently used for its high electronic conductivity properties and its low light absorption. Alternatively or additionally, when the system is intended to work in reflection, one of the electrically conductive materials may be of metallic nature.

The two layers of electroactive material may be identical layers of electrochromic material. The two layers of electrochromic electroactive material may be different, in particular having a complementary coloration, one of them having an anodic coloration, and the other having a cathodic coloration. According to another alternative, one of the layers of electroactive material is an electrochromic layer and the other layer of electroactive material is not electrochromic, acting only as ionic charge reservoir or a counterelectrode.

The electrochromic material(s) may in particular be chosen from:
(1) those of inorganic nature, such as oxides of tungsten, nickel, iridium, niobium, tin, bismuth, vanadium, nickel, antimony and tantalum, individually or the mixture of two of them or more; where appropriate as a mixture with at least one additional metal, such as titanium, tantalum, rhenium or cobalt;
(2) those of organic nature, such as electronically conductive polymers, for instance derivatives of polythiophene, polypyrrole or polyaniline;
(3) complexes, such as Prussian blue;
(4) metallopolymers;
(5) combinations of at least two electrochromic materials chosen from at least two families (1) to (4).

As electroactive materials, mention may be made of the polymers chosen from polyviologens, polymers containing bispyridinium, pyrylium, pyrazinium or quinoxalium units or groups, polyarylenes and polyheteroarylenes such as polythiophenes, for instance poly(3,4-ethylene-dioxythiophene) (PEDOT), poly[3,3-dimethyl-3,4-dihydro-2H-thieno-(3,4-b)dioxepine] (PropOT-Me₂), polyisothianophthene, polyisothianaphthenes (PITN), polyimides, polyquinones, polydisulfides, polyarylamines, such as polyanilines, polyarylenes, such as polyphenylenes or polyfluorenes, polyheteroarylenes such as polypyrroles, for instance poly(N-sulfonatopropoxy-3,4-propylenedioxypyrrole) (PPropOP-NPrS), polyindoles, copolymers of thiophene such as poly(octanoic acid 2-thiophen-3-ylethyl ester) (POTE), poly[decanedioic acid bis(2-thiophen-3-ylethyl)ester] (PDATE), poly{2-[(3-thienyl-carbonyl)oxy]ethyl 3-thiophene carboxylate} (PTOET), poly{2,3-bis[(3-thienylcarbonyl)oxy]propyl 3-thiophene carboxylate} (PTOPT), poly{3-[(3-thienylcarbonyl)oxy]-2,2-bis[(3-thienylcarbonyl)oxy]propyl 3-thiophene carboxylate} (PTOTPT), poly[3,6-bis(2-ethylenedioxy-thienyl)-N-methylcarbazole] (PBEDOT-NMeCz), polyarylenevinylenes such as poly(para-phenylene vinylenes) (PPV), polyheteroarylenevinylenes and polymers containing ferrocene units or groups.

One of the most widely used and most investigated electrochromic materials is tungsten oxide, which goes from a blue coloration to a transparent coloration according to its state of insertion of the charges. It is an electrochromic material with cathodic coloration, that is its colored state corresponds to the inserted (or reduced) state and its bleached state corresponds to the ejected (or oxidized) state.

During the construction of a five-layered electrochromic system, it is customary to combine it with an electrochromic material with an anodic coloration such as nickel oxide or iridium oxide, the coloration mechanism of which is complementary. The light contrast of the system is thereby amplified. All the materials mentioned above are of inorganic nature, but it is also possible to combine, with the inorganic electrochromic materials, complexes such as Prussian blue or metallopolymers or else organic materials such as electronically conductive polymers (derivatives of polythiophene, polypyrrole, or polyaniline, etc.), or even to use only one category of these materials.

The electroactive material that is not electrochromic may be a material that is optically neutral in the oxidation states in question, such as vanadium oxide. The counterelectrode may also consist of a thin layer of silver or a thin layer of carbon, which is highly conductive. To increase their transparency, these materials may be nanostructured.

The electrically controllable device of the present invention may be configured to form:
a sunroof for a motor vehicle, that can be activated autonomously, or a side window or a rear window for a motor vehicle or a rear-view mirror;
a windshield or a portion of a windshield of a motor vehicle, of an aircraft or of a ship, a vehicle sunroof;
an aircraft window;
a glazing unit for cranes, construction site vehicles or tractors;
a display panel for displaying graphical and/or alphanumeric information;
an interior or exterior glazing unit for buildings;
a skylight;
a display cabinet or store counter;
a glazing unit for protecting an object of the painting type;
an anti-glare computer screen;
glass furniture; and
a wall for separating two rooms inside a building.

The electrically controllable device according to the invention may operate in transmission or in reflection.

The substrates may be transparent, flat or curved, clear or bulk-tinted, opaque or opacified, of polygonal shape or at least partially curved.

At least one of the substrates may incorporate another functionality such as a solar control, antireflection or self-cleaning functionality.

Another subject of the present invention is a process for manufacturing the electrically controllable device as defined above in the context of the present invention, characterized in that the various layers which form it are assembled by calendering or laminating, optionally with heating.

The present invention finally relates to a single or multiple glazing unit, characterized in that it comprises an electrically controllable device as defined above in the context of the present invention.

The various layers making up said system can be assembled as a single or multiple glazing unit.

The following examples illustrate the present invention without however limiting the scope thereof.

The “K-glass™” glass used in these examples is a glass covered with an electrically conductive layer of SnO₂:F with a sheet resistance R_{□} equal to 20.5Ω/□ (glass sold under this name by Pilkington).

The PEDOT (poly(3,4-ethylenedioxythiophene))/PSS (polystyrene sulfonate) used in the examples is that sold by HC Starck under the name Clevios™ (formerly called Baytron®). In order to be able to be deposited on the “K-glass™” glasses, the Clevios™ was reformulated and the CPP 105D recipe supplied by HC Starck was used.

### EXAMPLE 1

### Preparation of an Electrochromic Cell

glass having a layer of SnO₂:F;
PEDOT/PSS layer;
self-supported electrolyte layer: non-woven web of
glass+lithium perchlorate+propylene carbonate;
PEDOT/PSS layer in the reduced state, reduced by lithium perchlorate;
glass having a layer of SnO₂:F.

A solution of propylene carbonate containing 0.15 mol·L⁻¹ of lithium perchlorate was prepared. The solution was stirred for 30 minutes.

A non-woven web of glass with an index of 1.55, obtained by a dry route, having a thickness of 500 μm and having fibers with a thickness of 13 μmm was impregnated with this solution.

Electrochromic layers were manufactured by depositing a PEDOT/PSS film, having a wet thickness of 150 μm two K-glass™ glasses and they were dried for 5 minutes at 120° C. One of the two sheets of “K-glass™” glass covered with PEDOT/PSS was reduced in a 1 mol·L⁻¹ solution of lithium perchlorate in acetonitrile, rinsed with ethanol and dried with an air gun.

The impregnated web was extended over a “K-glass™” glass substrate on the PEDOT/PSS side. Strips of double-sided adhesive were placed at the periphery, then the web was covered with a second “K-glass™” glass substrate, with the PEDOT/PSS side turned toward the impregnated web. The electrochromic device thus manufactured, the active surface of which is 8×8 cm², was autoclaved at 95° C. The periphery of the electrochromic cell was surrounded with epoxy adhesive, which acts as an encapsulant and enables the cohesion between the two glass substrates and the electrolyte layer to be strengthened.

The performances of this electrochromic device are given in table 1 below:

TABLE 1

| | | Switching | | |
|---|---|---|---|---|
| | T_{L} (%) | time | a* | b* |
| Colored state, | 19.5 | 1 s | −7.31 | 25.54 |
| powered at 2 V | | | | |
| Bleached state, at | 29.9 | 1 s | −2.63 | −12.27 |
| 0 V | | | | |

### EXAMPLE 2

### Preparation of an Electrochromic Cell

glass having a layer of SnO₂:F;
PEDOT/PSS layer;
self-supported electrolyte layer: non-woven web of
polypropylene fibers+lithium perchlorate+propylene carbonate;
PEDOT/PSS layer in the reduced state, reduced by lithium perchlorate;
glass having a layer of SnO₂:F.

A self-supported electrolyte layer was manufactured by impregnating a non-woven web of polypropylene fibers at 45 g/m² and having a thickness of around 350 μm in the solution of propylene carbonate containing 0.15 mol·L⁻¹ of lithium perchlorate described in example 1.

Electrochromic layers were manufactured by depositing a PEDOT/PSS film, having a wet thickness of 250 μm, on two K-glass™ glasses and they were dried for 5 minutes at 120° C. One of the two sheets of “K-glass™” glass covered with PEDOT/PSS was reduced in a 1 mol·L⁻¹ solution of lithium perchlorate in acetonitrile, rinsed with ethanol and dried with an air gun.

An electrochromic cell was then prepared as described in example 1. The performances of this new electrochromic device are given in table 2:

TABLE 2

| | T_{L} | Switching | | |
|---|---|---|---|---|
| | (%) | time | a* | b* |
| Colored state, | 4.6 | 4 s | 0.97 | −43.61 |
| powered at 2 V | | | | |
| Bleached state, | 12.5 | 3 s | 0.49 | −20.16 |
| at 0 V | | | | |

### EXAMPLE 3

### Preparation of an Electrochromic Cell

glass having a layer of SnO₂:F;
PEDOT/PSS layer;
self-supported electrolyte layer: non-woven web of glass+lithium perchlorate+propylene carbonate;
PEDOT/PSS layer in the reduced state, reduced by lithium perchlorate;
glass having a layer of SnO₂:F.

A self-supported electrolyte layer was manufactured as described in example 1 and electrochromic layers were manufactured as described in example 2.

An electrochromic cell was then prepared as described in example 1. The performances of this new electrochromic device are given in table 3:

TABLE 3

| | T_{L} | Switching | | |
|---|---|---|---|---|
| | (%) | time | a* | b* |
| Colored state, | 4.5 | 4 s | −1.03 | −36.41 |
| powered at 2 V | | | | |
| Bleached state, | 12.9 | 5 s | −0.07 | −18.24 |
| at 0 V | | | | |

### EXAMPLE 4

### Preparation of an Electrochromic Cell

glass having a layer of ITO;
layer of WOₓ (electrochromic layer);
self-supported electrolyte layer: non-woven web of glass+lithium perchlorate+propylene carbonate;
layer of IrOₓ (counterelectrode layer);
glass having a layer of ITO.

A self-supported electrolyte layer was manufactured as described in example 1.

The electrochromic layer and the counterelectrode layer are layers, respectively, of tungsten oxide and of iridium oxide, obtained by magnetron sputtering onto glass covered with a conductive layer of ITO.

An electrochromic cell was then prepared as described in example 1. The performances of this new electrochromic device are given in table 4:

TABLE 4

| | T_{L} | | |
|---|---|---|---|
| | (%) | a* | b* |
| Colored state, | 11.7 | −4.75 | −7.70 |
| powered at −1.5 V | | | |
| Bleached state, at | 33.2 | −3.87 | −6.06 |
| 1 V | | | |

### EXAMPLE 5

### Choice of the Impregnation Liquid

In order to reduce the haze of the electrochromic glazing units, the electrolyte film of which is based on a non-woven web of glass with an index of 1.55, samples of web from example 1 were impregnated in various liquids having a high index before being encapsulated between two glasses.

Listed in table 5 below are the light transmission measurements:

Total light transmission (Minolta); and
Light transmission, diffusion and haze.

TABLE 5

| | | Measurement device | | | |
|---|---|---|---|---|---|
| | | | Haze meter | | |
| | | Minolta | Tt | | Haze |
| Liquid | Index | T_{L} (%) | (%) | Td (%) | (%) |
| Propylene | 1.422 | | 83.8 | 65.9 | 78.6 |
| carbonate | | | | | |
| Dimethylphthalate | 1.515 | 88.2 | 88.2 | 1.7 | 1.9 |
| Polyethylene | 1.528 | 88.1 | 88.4 | 8.2 | 9.3 |
| glycol dibenzoate | | | | | |
| Dipropylene | 1.528 | 88.7 | 87.9 | 9.01 | 10.3 |
| glycol | | | | | |
| dibenzonate | | | | | |
| Diethylene glycol | 1.544 | 87.5 | 87.9 | 15.30 | 17.4 |
| dibenzoate | | | | | |

1. An electrolyte material, which is in the form of a self-supported layer, comprising a matrix comprising a textile sheet (TS) comprising mineral fibers or a stack of sheets comprising the textile sheet (TS),
wherein the textile sheet (TS) or the stack is impregnated with a solubilization liquid (L) that has solubilized ionic charges, wherein the mineral fibers of the matrix and the solubilization liquid (L) have indices that are substantially equal, with a difference of at most 1.0.

2. The electrolyte material of claim 1, wherein the textile sheet (TS) is a non-woven web, a non-woven mat, a woven fabric, or a knit fabric.

3-6. (canceled)

7. The electrolyte material of claim 1, wherein the solubilization liquid (L) further comprises a thickener solubilized in the solubilization liquid (L) so as to form a gel.

8-9. (canceled)

10. The electrolyte material of claim 1, wherein the mineral fibers forming the matrix and the solubilization liquid (L) have indices that are substantially equal, with a difference of at most 0.05.

11. (canceled)

12. An electrically controllable device having variable optical properties, comprising the electrolyte material of claim 1.

13. The electrically controllable device of claim 12, comprising, as a stack of layers:
a first substrate having a glass function (V1);
a first electronically conductive layer (TCC1) with an associated current feed;
a first layer of an electroactive material; the electrolyte material;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

14. (canceled)

15. The electrically controllable device of claim 13, wherein the two layers of electrochromic electroactive material are different, one having an anodic coloration, and the other having a cathodic coloration.

16-17. (canceled)

18. The electrolyte material of claim 2, wherein the non-woven web, non-woven mat, woven fabric, or knit fabric is coated with a binder at least partially soluble in the solubilization liquid (L) in order to form a gel.

19. The electrolyte material of claim 1, wherein the mineral fibers are glass fibers.

20. The electrolyte material of claim 19, wherein the solubilizing liquid (L) is dimethylphthalate, polyethylene glycol dibenzoate, or dipropylene glycol dibenzonate.

21. The electrolyte material of claim 20, wherein the solubilizing liquid (L) is dimethylphthalate.

22. The electrolyte material of claim 20, wherein the solubilizing liquid (L) is polyethylene glycol dibenzoate.

23. The electrolyte material of claim 20, wherein the solubilizing liquid (L) is dipropylene glycol dibenzonate.

24. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 2;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

25. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 7;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

26. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 10;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

27. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 18;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

28. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 19;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

29. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 20;
a second layer of an ionic charge reservoir electroactive material;
a second electronically conductive layer (TCC2) with an associated current feed; and
a second substrate having a glass function (V2),
wherein at least one of the two layers of electroactive material is electrochromic.

30. An electrically controllable device having variable optical properties, comprising, as a stack of layers:
a first substrate having a glass function (V1);
a first electronically conductive layer (TCC1) with an associated current feed;
a first layer of an electroactive material;
the electrolyte material of claim 21;
a second layer of an ionic charge reservoir electroactive material;
a second electronically conductive layer (TCC2) with an associated current feed; and
a second substrate having a glass function (V2),
wherein at least one of the two layers of electroactive material is electrochromic.
